(19) United States
(12) Patent Application Publication
(10) Pub. No.: US 2008/0077638 A1
(43) Pub. Date: Mar. 27, 2008

(54) Distributed storage in a computing environment

(75) Inventors: David Hugh Monk, Redmond, WA (US); Kenneth Lloyd Alverson, Redmond, WA (US); John Budig, Duvall, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/525,007

(22) Filed: Sep. 21, 2006

(51) Int. Cl. G06F 17/30

(52) U.S. Cl. 707/205

(57) ABSTRACT

Embodiments provide an amount of distributed storage by using a number of computing devices which are distributed throughout a computing environment. Each computing device can be associated with a group policy and can provide an amount of storage to the computing environment. For example, each computing device can provide a maximum amount of free space to the computing environment. The amount of storage provided by each computing device can be collected and combined to provide an amount of combined distributed space. The combined distributed space across the computing environment can be associated with each computing device as a mapped drive. The combined distributed space can be used to provide a certain level or amount of redundancy for data stored in the computing environment. The combined distributed space also provides a cost benefit by utilizing unused space of each computing device.

### BACKGROUND

A certain level of redundancy is typically warranted when storing and managing data due to the inherent vulnerability of electronic storage. For example, computing devices can be irreparably damaged by viruses, electrical impulses, and other events, resulting in the loss and/or corruption of stored data. It is just an accepted fact that most digital storage mechanisms and mediums are not impervious to corruption and damage. Thus, it is desirable to have a certain level of backup or redundancy to rely upon when necessary. For example, it is common, and often necessary, to retain multiple copies of certain data should such an event occur.

Expensive file servers are routinely added to a computer network, such as an enterprise network, to support the ever increasing data load. However, adding file servers to support the data load is costly not only in terms of the physical machines and accompanying software, but also due to the maintenance and up-keep of the file servers. If the amount of stored data tracks Moore's law, the amount of space required to store the data should double each year. Thus, the exercise to implement file servers and other costly data storage mechanisms becomes untenable. Adding to the issue is the amount of unused space on any given computing device that may be associated with such a network. For example, it is not uncommon for a desktop or laptop computer in the network to have a large amount of free or unused hard drive space. This unused space is costly in terms of the potential storage capability that is not being utilized.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide an amount of distributed storage by using a number of computing devices which are distributed throughout a computing environment. Each computing device can be associated with a group policy and provides an amount of storage to the computing environment. The amount of storage provided by each computer can be collected and combined to provide an amount of combined distributed space. Thereafter, the combined distributed space across the computing environment can be associated with each computing device as a mapped drive. The combined distributed space allows for a certain level or amount of redundancy to be implemented in the computing environment.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of a computing environment.

FIG. 2 is a flowchart of a procedure for using free space associated with a number of computing devices of a computing network.

FIG. 3 is a flowchart of a procedure for accessing data.

FIG. 4 s a block diagram illustrating a computing environment for implementation of various embodiments described herein.

### DETAILED DESCRIPTION

Embodiments provide distributed storage functionality. In an embodiment, an amount of distributed storage is provided by using a number of computing devices which are distributed throughout a computing environment, such as a computing network. In one embodiment, a number of computing devices are collectively associated with a group policy. Each computing device associated with the group policy provides or proffers an amount of storage, wherein the amount of storage provided by each computing device can be collected and combined. Thereafter, the combined distributed space can be provided to each computing device as a mapped drive. The combined distributed space allows data to be stored in the computing environment with a certain level or amount of redundancy.

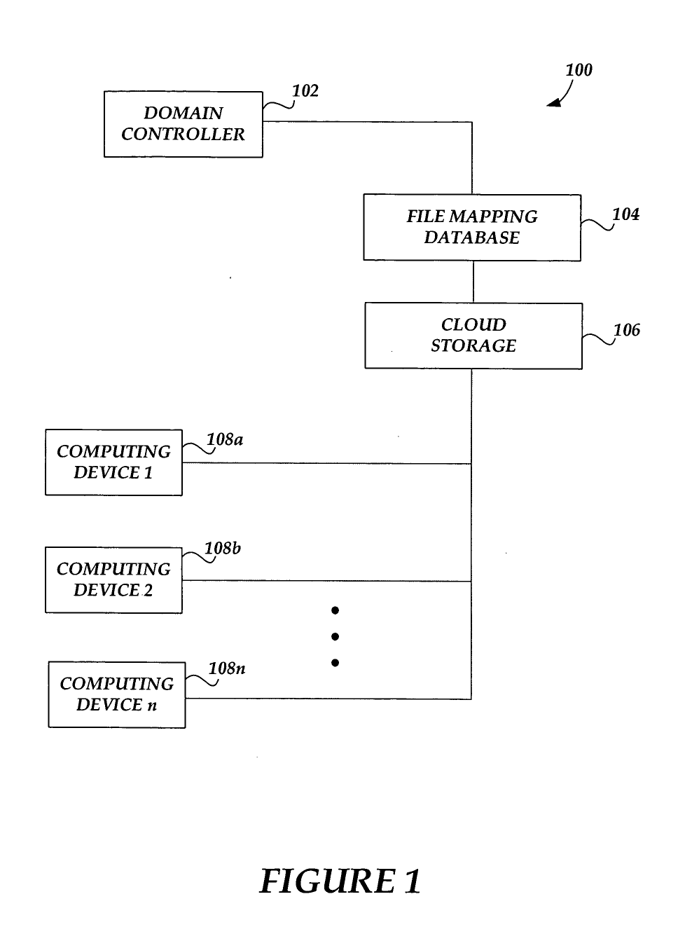

FIG. 1 is a block diagram of a computing environment 100, under an embodiment. The computing environment 100 can be described as a network of components wherein the associated components are communicatively coupled in such a manner to provide a desired operational functionality. In one embodiment, the computing environment 100 is a distributed computer network, such as a local-area network (LAN), wide-area network (WAN), or any other network that allows one or more computing devices, communication devices, databases, etc., to be communicatively coupled according to a desired implementation. The components of the computing environment 100 can be communicatively coupled to one another using wired, wireless, combinations of wired and wireless, and other communication techniques.

As shown in FIG. 1 and in accordance with this embodiment, the computing environment 100 includes a domain controller 102, a file mapping database 104, a cloud storage 106, and a number of computing devices 108a-108n. The computing devices 108a-108n can include desktop computers, laptop computers, server computers, handheld devices, other communication devices, etc. and combinations thereof. In one embodiment, the domain controller 102 comprises a computing device, such as a serving computer, configured to manage aspects of the computing environment 100, but is not so limited. In other embodiments, more than one domain controller can be included in the computing environment 100.

The domain controller 102 is configured to manage any free or unused space of the number of computing devices 108a-108n. As described further below, the domain controller 102 has knowledge of files/fragments stored on the cloud storage 106, any computing devices that are currently associated and/or connected to the computing environment 100, how many copies of each fragment/file exist, etc. If the domain controller 102 determines that an amount of redundancy is decreasing or not at a preferred level, it can replicate data on one or more computing devices in the computing environment 100 to increase the amount of redundancy. The domain controller 102 is configured to parse a file into one or more fragments and distribute the one or more fragments according to a desired amount of redundancy. For example, the domain controller 102 can parse a 50 Mb file into 1 Mb fragments and distribute the fragments and/or copies thereof to an amount of storage associated with the computing devices.

The domain controller 102 can comprise a server including a server operating system having an associated directory service, such as ACTIVE DIRECTORY for example. As described below, the domain controller 102 is configured to manage free space associated with one or more of the computing devices 108a-108n to provide an amount of available storage for a desired use. For example, even with high redundancy (e.g. overhead), terabytes of potential storage can be made available by using the domain controller 102 to manage the free space associated with one or more of the computing devices 108a-108n. Additional storage capacity can be easily and efficiently implemented by using the existing computing devices 108a-108n associated with the computing environment 100, since additional hardware is unnecessary.

The domain controller 102 and the directory service are configured to store information about the associated domain including schema and configuration directory partitions. For example, the directory service can be used to assign enterprise-wide policies, deploy programs and apply critical and other updates to computing devices. Additionally, the directory service can be used to store information about objects in the computing environment 100 and provide this and other information to users and administrators associated with the computing environment 100. The information can be stored in a central, organized, accessible database, such as the file mapping database 104.

A group policy can be described as an infrastructure functionality allowing for the implementation of specific configurations for users and computing devices associated with the computing environment 100. The group policy settings are contained in group policy objects and can be implemented using the directory service. The group policy can be used to provide consistent access to applications, application settings, roaming user profiles, data, etc. from any managed computing device 108a-108n. A group policy also can be directed to Organizational Units (OU). An OU can be used to classify computing devices, users, and/or a combination of both. Group policy settings can be configured and pushed to the computing devices 108a-108n associated with the computing environment 100.

The file mapping database 104 serves as a repository for information associated with the computing environment 100. The file mapping database 104 includes the mapping information associated with data that is stored across multiple computing devices (e.g. mapping of fragments associated with each computing device) as part of the cloud storage 106. The file mapping database 104 includes the information for which the domain controller 102 can access when responding to various requests from one or more of the number of computing devices 108a-108n. In one embodiment, the file mapping database 104 includes information regarding the location of certain file fragments on one or more of the number of computing devices 108a-108n.

The domain controller 102 can use the file mapping database 104 to store and retrieve information associated with the management of the number of computing devices 108a-108n. In one embodiment, the domain controller 102 includes structured query language (SQL) server functionality. The domain controller 102 is configured to use the mapping information stored in the file mapping database 104 to provide a mapped network drive (an accessible NTFS network drive for example) to a number of computing devices associated with a group policy. Once a user properly joins the domain (e.g. after providing valid authentication and security credentials) and is part of the group policy, the mapped network drive and associated cloud storage 106 can be made available to the user for interaction therewith.

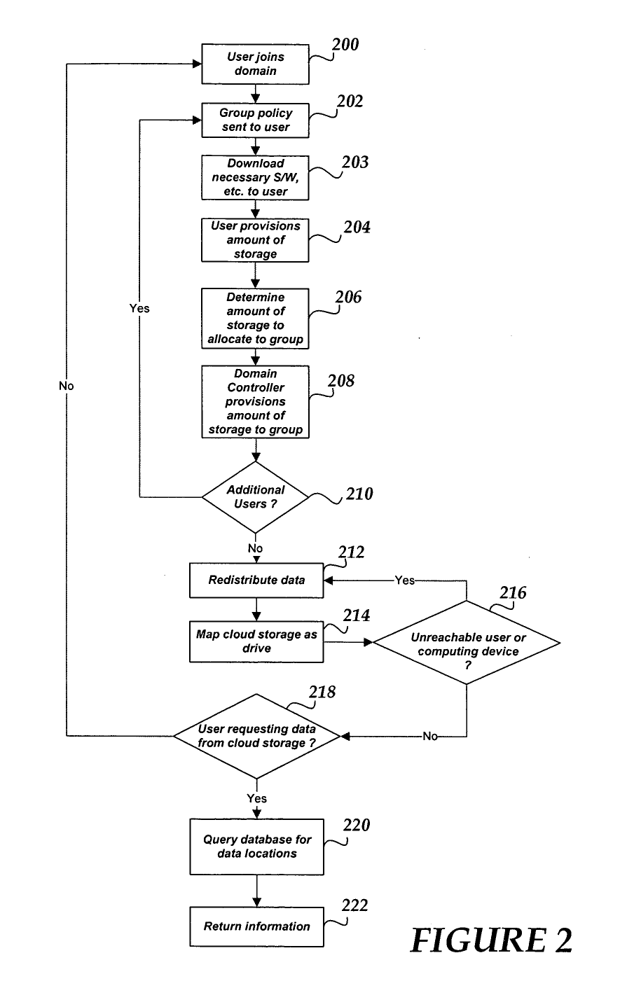

Referring now to FIG. 2, a flowchart illustrates a procedure for using free space or unutilized storage associated with a number of computing devices of a computing network, under an embodiment. The free space can be collected and combined to provide extra storage capacity to the computing devices and other systems associated with the network. The extra storage can be used to store and backup data, but is not so limited. For example, the collected space across the network can be used as required or at desired times to redundantly store data, such as file fragments associated with a certain file or files.

For example, the flow can track an exemplary enterprise situation, wherein a number of computers of the enterprise network typically include an amount of unused or free hard drive space. The unused hard drive space of each computer can be collected and combined to provide extra storage (e.g. cloud storage 106 of FIG. 1) to users associated with the enterprise. In one embodiment, a percentage or fixed amount of the hard drive space of one or more computing devices can be collected and combined to provide extra storage.

As described below, each computer can provide a portion (e.g. as dictated by group policy) of a storage area to be associated with the cloud storage 106, such as a portion of an associated hard drive for example. This storage can be used to store fragments of a file and/or files that exist in the shared cloud storage 106. As described above, this storage, or a portion thereof, is accessible to computers of the group as a mapped drive. The cloud storage 106 can be described as an aggregation of an amount of the available free space of each computer associated with the group policy. In an embodiment, the domain controller 102 is configured to provide a percentage or fixed amount of the collected free space to users associated with the group policy.

In an embodiment, the file fragments comprise independent network coded representations or versions of the same fragments located in the shared cloud storage 106. Due to the network coding, there can be N versions of any one fragment, wherein any M (N>M) of which are sufficient to regenerate an original file fragment. N and M would be decided based on the degree of redundancy specified by a particular group policy. Correspondingly, data, including file fragments and other data representations, can be redistributed to other computers (or other systems associated with the group policy) if a computer in the group should fail or become inoperable for some reason.

Thus, the data remains available if one or more computers should fail, become inoperable, or leave the group for example, since the data can still be retrieved from a different computer or computers. This follows from the redundant capability provided by utilizing the unused hard drive space of the number of computers associated with the network or group. If there happens to be a sudden increase in the number of unreachable computers or a trend that could cause potential danger to data integrity, the domain controller 102 is configured to implement additional data backup steps to prevent data loss. For example, if a particular computer fails or becomes unreachable, the domain controller 102 can redistribute the data that was stored on this computer to one or more other functional computers associated with the network to maintain the required amount of redundancy.

As shown in FIG. 2, at 200 a user joins a domain after providing valid authentication credentials (e.g. username, password, etc.). As described above, the domain can include a number of computing devices 108a-108n and other interactive components. At 202, the domain controller 102 pushes or sends a group policy to the user. The group policy can dictate an amount of free space associated with the new user to be provisioned to the cloud storage 106, but is not so limited. The group policy may be associated with different domains or isolated to a limited number of computing devices. In addition to the group policy, the domain controller 102 can push and/or send other information to users. For example, the domain controller 102 can push one or more executables to a user, wherein the one or more executables are made to execute once a user has logged into the domain.

At 203, the domain controller 102 can transfer any necessary software and/or other functionality to the user device. At 204, the joining user dedicates an amount of its available storage to the cloud storage 106 by informing the domain controller 102 of an amount of available storage, or percentage thereof, associated with the computing device. Alternatively, a provisioned executable can automatically determine the amount of free space available to the cloud storage 106 by examining the hard drive or other storage areas of the associated computing device and communicating the information to the domain controller 102 at a desired time. At 206, the domain controller determines the amount of storage that is to be associated with the group based in part on the amount of available free space of each computing device that is currently associated with the group. For example, the determination can be based on an amount of available storage that will be provided and accessible to users associated with the group policy. As further example, the domain controller 102 can base the amount of storage that is to be associated with the group based on a memory usage history of each computing device.

The amount of available storage is based in part on the number of computing devices associated with the group policy and the amount of free space on each computing device in the group. Having knowledge of the available free space, the domain controller 102 can set a desired amount of redundancy/overhead for the cloud storage 106 to account for failures and other contingencies associated with the group. Correspondingly, the domain controller 102 can proactively defend against data loss by automatically replicating and/or redistributing data in the cloud storage 106 if a computing device should become inoperable and/or if some other issue or contingency adversely affects the stored data.

At 208, after determining the amount of available and accessible storage associated with the group, the domain controller 102 provisions an amount of storage to users associated with the group policy. Again, the provisioned amount of storage can be based upon a desired amount of redundancy and any overhead associated with the group. At 210, it is determined whether there are additional users who would like to join the group. The flow returns to 202 if there is an additional user attempting to join the group. Otherwise the flow continues to 212, where the domain controller 102 can redistribute data throughout the group based on the updated storage made available in the cloud storage 106 due to the addition of another computing device. At this point it is assumed that the domain controller 102 has previously written to the cloud storage 106 by distributing the data to an amount of available storage of the computing devices associated with the group policy.

As described above, the domain controller 102 is configured to distribute data to the computing devices associated with the cloud storage so that if a particular computing device fails, the data is still available on a different computing device. For example, the domain controller 102 can distribute and/or retrieve the data based on the amount of available storage and/or the proximity/location of a particular computing device. At 214, the domain controller 102 makes the cloud storage 106 available to the group as a network drive which can be mapped to each user of the group. Alternatively, a received executable can automatically map an amount of the available storage of the respective computing device to cloud storage 106.

At 216, it is determined whether a group participant has left the group or whether a computing device has become otherwise unreachable. If a group participant has left the group or a computing device has become otherwise unreachable, the flow return to 212 and the domain controller 102 can redistribute data to the one or more remaining participants of the group. Otherwise, the flow continues to 218, and it is determined whether a user is requesting data, such as a file or file fragment for example, from the cloud storage 106. If a user is not requesting data from the cloud storage 106, the flow returns to 200.

However, if a user has made a request for data, the flow proceeds to 220 and the domain controller 102 queries the file mapping database 104 to determine one or more locations of the data based on the user request. For example, the request may be for a particular file, a portion of a file, etc. The fragments of a requested file may reside on a number of computing devices 108a-108n and the file mapping database 104 contains the mapping information required to locate each fragment and to determine an amount of redundancy associated with each fragment. That is, the domain controller 102 can use the information of the file mapping database 104 to retrieve the requested data as quickly and efficiently as possible, while providing an amount of redundant storage capability. Once located, the domain controller 102 returns the information required to locate the requested data at 222.

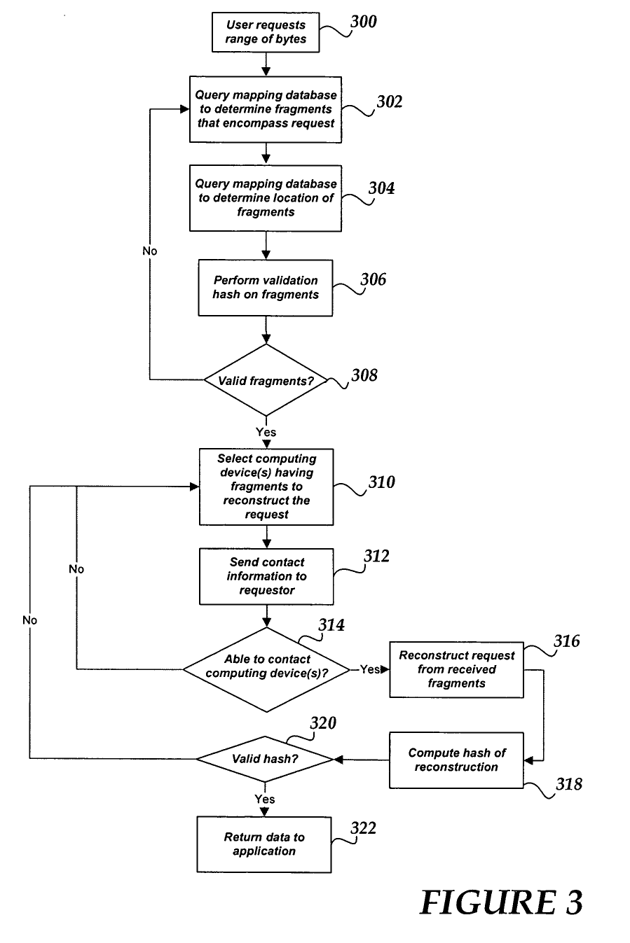

Referring now to FIG. 3, a flowchart illustrates a procedure for accessing data from the cloud storage 106, under an embodiment. At 300, a user associated with a group policy sends a data request to the domain controller 102. In one embodiment, the request can include a request for a range of bytes associated with a portion of file or an entire file. A user can request a range of bytes, a fragment or fragments associated with a file or other data, and/or a portion of a file. For example, a user may only want to view a portion of a video file, listen to a portion of an audio file, access part of a database, etc., wherein the entire file (and data associated therewith) is not required or desired. At 302, the domain controller 102 queries the file mapping database 104 to determine the one or more fragment(s) and/or associated data that encompasses the user's request.

At 304, the domain controller 102 queries the file mapping database 104 to determine the location(s) of the one or more file fragments in the cloud storage 106. As described above, depending on the level of redundancy/overhead, file fragments may be stored on multiple computing devices throughout the computing environment. At 306, the user's computing device performs a validation hash to determine the validity of the located fragment or fragments.

At 308, if the validation hash is invalid, the flow returns to 302, and the domain controller 102 waits for another data request. The domain controller 102 can remove entries from the file mapping database 104 for inaccessible and/or corrupt computing devices and/or data. If the validation hash is valid, the flow proceeds to 310, and the domain controller 102 selects one or more computing devices having the requested fragment or fragments in order to reconstruct the user request. For example, the domain controller 102 can select a computing device to obtain a particular file fragment based on the proximity of the associated computing device to the requester, in addition to other selection factors.

At 312, the domain controller 102 sends the contact or location information of the computing device or devices having the fragment or fragments to the requester. In an alternative embodiment, the domain controller 102 can automatically collect and/or distribute the located fragment or fragments, including determining the validity of the located fragment or fragments. At 314, if the user is unable to communicate with the computing device or devices, the flow returns to 310 and the domain controller 102 selects a different computing device and/or devices to satisfy the request. Again, the domain controller 102 can remove entries from the file mapping database 104 for inaccessible computing devices and/or data.

Otherwise, the flow proceeds to 316 wherein the user request is satisfied and the user receives the requested fragment or fragments from the computing device or devices. At 318, the requesting computing device can perform a validation hash on the received fragment or fragments. For example, the domain controller 102 can send the hash of the expected fragment or fragments, and if the hash is invalid, then the data is corrupt. If the validation hash is invalid at 320, the flow returns to 310 and the domain controller 102 selects a different computing device and/or devices in attempting to satisfy the request. At this point, the domain controller 102 can remove or label/mark a computing device whose data resulted in the invalid hash. Otherwise, the validated data is returned, such as to a calling application for example, and the flow ends. While certain procedures are described above, other arrangements and additional or fewer steps can be used.

As described above, an amount of storage can be provided by utilizing free space of the number of computing devices 108a-108n associated with the computing environment 100. For example, an amount of the available hard drive space of a number of computing devices can be utilized to provide a distributed amount of shared storage in a computing network. Depending on the number of computing devices and associated free or available space, a vast amount of storage can be realized even with high levels of overhead/redundancy.

For example, it has been seen that the amount of storage available in desktops can double approximately every 18 months, and since the utilization of this space typically does not follow such a trend, the potential storage capability provided across such a computing environment 100 should continue to increase. The ability to make this storage reliable for a low cost is particularly attractive, since there is minimal associated cost to implement the shared storage capability in such as computing environment 100. The Table below illustrates the potential storage capability based on a number of machines having a certain amount available space to be utilized as a shared network drive.

TABLE

| | 20 GB of free space per | | |
|---|---|---|---|
| | machine in network. | | |
| # Machines | 80% Overhead | 95% Overhead | 99% Overhead |
| 10 | 30 GB | 10 GB | 2 GB |
| 50 | 150 GB | 50 GB | 10 GB |
| 100 | 300 GB | 100 GB | 20 GB |
| 500 | 1,500 GB | 500 GB | 100 GB |
| 1,000 | 3,000 GB | 1,000 GB | 200 GB |
| 5,000 | 15,000 GB | 5,000 GB | 1,000 GB |
| 10,000 | 30,000 GB | 10,000 GB | 2,000 GB |
| 50,000 | 150,000 GB | 50,000 GB | 10,000 GB |
| 100,000 | 300,000 GB | 100,000 GB | 20,000 GB |

Additionally, security issues can be mitigated by requiring valid credentials to join a domain. Moreover, the domain controller 102 can set access controls (e.g. access control lists) for fragments and/or files on the cloud storage 106, thereby preventing unauthorized access. In addition, data can be protected on the local computing device, using an encryption technique, such as NTFS encryption for example. The local encryption can prevent a user from reading anyone else's data if they were to examine the contents of a participating computing device's cloud store. Additionally, security against a compromised computing device can be provided by storing a cryptographic hash of a fragment on the domain controller 102. If a participating computing device returns a file fragment that does not match the stored hash when a user attempts to use the file, the participant can be treated as if it had failed and removed from the cloud until corrective action is taken.

### Exemplary Operating Environment

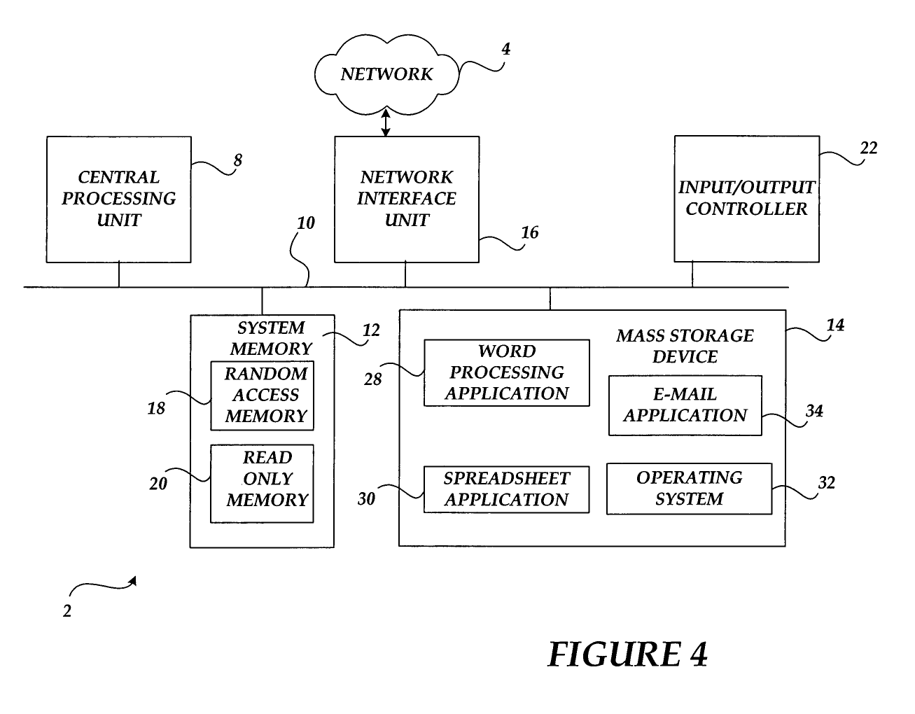

Referring now to FIG. 4, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 4, an illustrative operating environment for embodiments of the invention will be described. As shown in FIG. 4, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 32, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 32 suitable for controlling the operation of a networked personal computer, such as the WINDOWS XP operating system from MICROSOFT CORPORATION of Redmond, Wash. The mass storage device 14 and RAM 18 may also store one or more program modules. In particular, the mass storage device 14 and the RAM 18 may store application programs, such as a word processing application 28, a spreadsheet application 30, e-mail application 34, drawing application, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

We claim:

1. A system to manage an amount of storage comprising:
a number of computing devices communicatively coupled in a computing environment, wherein each computing device includes an amount of free storage;
a domain controller to collect and combine the amount of free storage associated with each computing device, wherein the domain controller provides an amount of the combined free storage to the computing environment; and,
a database to store information associated with the combined free storage.

2. The system of claim 1, wherein the domain controller is configured to redundantly store data using the combined free storage.

3. The system of claim 1, wherein the database further comprises a file mapping database including mapping information to track data stored in the combined free storage.

4. The system of claim 1, wherein each computing device is configured to map the combined free storage as a network drive.

5. The system of claim 1, wherein the amount of free storage associated with each computing device comprises an amount of free space of a hard drive.

6. The system of claim 5, wherein the domain controller is configured to collect and combine the amount of free space of each hard drive and provide an amount of the combined hard drive free space to each computing device associated with the computing environment.

7. The system of claim 1, wherein the domain controller is configured to communicate a group policy to each computing device associated with the computing environment.

8. The system of claim 7, wherein the domain controller is further configured to communicate one or more executables to each computing device associated with the group policy, wherein the one or more executables can execute once a computing device properly joins the computing environment.

9. The system of claim 1, wherein the domain controller is configured to replicate data on one or more computing devices in the computing environment based on a desired amount of redundancy associated with the data.

10. The system of claim 9, wherein the domain controller is further configured to store data as one or more fragments, wherein the one or more fragments comprise independent network coded representations.

11. The system of claim 1, wherein the domain controller is configured to use the database to locate stored data, wherein the located data can be provided based on at least one of a location of the stored data and a requesting location.

12. A computer readable medium including executable instructions which, when executed, locate data by:
associating a number of computing devices with a group policy, wherein the group policy is associated with a domain;
determining one or more fragments that correspond to a data request, wherein the one or more fragments are distributed in an amount of storage of the number of computing devices associated with the group policy;
locating the one or more fragments in the domain; and
reconstructing the requested data from the one or more located fragments.

13. The computer-readable medium of claim 12, wherein the instructions, when executed, locate data by querying a file mapping database to determine the one or more fragments that correspond to the data request and to locate the one or more fragments in hard drive storage of the number of computing devices.

14. The computer-readable medium of claim 13, wherein the instructions, when executed, locate data by performing a validating hash on the one or more fragments located in the hard drive storage of the number of computing devices.

15. The computer-readable medium of claim 12, wherein the instructions, when executed, locate data by reconstructing the requested data from the one or more located fragments by using one or more fragments from the hard drive storage of the number of computing devices according to a location associated with one or more of the number of computing devices.

16. The computer-readable medium of claim 15, wherein the instructions, when executed, locate data by performing a hash on the data reconstruction, wherein the requested data is returned if the hash is valid.

17. A method of providing storage for data comprising:
associating a number of computing devices with a domain;
determining an amount of available storage of the number of computing devices associated with the domain;
collecting the amount of available storage; and
creating a cloud storage from the collected amount of available storage, wherein the cloud storage is available to the number of computing devices associated with the domain.

18. The method of claim 17, further comprising determining and collecting an amount of available hard drive storage of the number of computing devices associated with the domain, wherein the cloud storage includes the collected amount of hard drive storage.

19. The method of claim 18, further comprising redundantly distributing data to the cloud storage, such that the data is distributed to provide a redundant virtual file system for the domain.

20. The method of claim 17, further comprising retrieving data from the cloud storage based on a location of a particular computing device associated with the data.
